(19) United States
(12) Patent Application Publication
(10) Pub. No.: US 2018/0100740 A1
(43) Pub. Date: Apr. 12, 2018

(54) METHOD AND APPARATUS FOR PLANNING PATH

(71) Applicant: Hanwha Techwin Co., Ltd., Changwon-si (KR)

(72) Inventors: Jeong Yeon SEO, Changwon-si (KR); Jun Ho LEE, Changwon-si (KR); Seon Young LEE, Changwon-si (KR)

(73) Assignee: Hanwha Techwin Co., Ltd., Changwon-si (KR)

(21) Appl. No.: 15/470,039

(22) Filed: Mar. 27, 2017

(30) Foreign Application Priority Data
Oct. 10, 2016 (KR) 10-2016-0130826

(51) Int. Cl. G01C 21/20; A01M 7/00; A01B 69/00; G08G 5/00; B64C 39/02

(52) U.S. Cl. CPC G01C 21/20; A01M 7/0089; A01B 69/007; B64C 2201/127; B64C 39/024; B64C 2201/141; B64C 2201/128; G08G 5/006

(57) ABSTRACT

A method for planning a path of a working device includes: generating a polygon corresponding to a work area of the working device and generating an edge data structure based on the polygon; generating a survey area based on the polygon; generating a plurality of survey lines at a predetermined interval in the survey area; detecting at least one intersection between each of edges of the polygon and each of the plurality of survey lines based on the edge data structure; and generating the path of the working device in the work area based on the at least one intersection.

### CROSS-REFERENCE TO RELATED APPLICATION

This application claims priority from Korean Patent Application No. 10-2016-0130826, filed on Oct. 10, 2016, in the Korean Intellectual Property Office, the disclosure of which is incorporated herein by reference in its entirety.

### BACKGROUND

### 1. Field

Methods and apparatus consistent with exemplary embodiments relate to a method and apparatus for planning a path.

### 2. Description of the Related Art

As interest in transportation means for performing physical tasks has recently increased, many studies have been made on methods of planning travel paths of transportation means. However, existing planning methods have problems in that the methods are time-consuming and imprecise. In particular, a method including a pre-process of dividing an area for which a path is to be calculated into small boxes, called grids, and generating a path along which the area is circulated in a zigzag fashion at predetermined intervals has problems in that it is difficult for a non-expert to understand and use it. Also, when the area is changed, a new path for the new changed area has to be re-calculated.

### SUMMARY

One or more exemplary embodiments provide a method and apparatus for planning a path so that an efficient travel path may be provided.

Additional aspects will be set forth in part in the description which follows and, in part, will be apparent from the description, or may be learned by practice of the presented exemplary embodiments.

According to an aspect of an exemplary embodiment, there is provided a method of planning a path including: generating an edge data structure of a polygon that represents a work area; generating a survey area including the polygon; generating a plurality of survey lines at a predetermined interval from one another in the survey area; detecting intersections between edges of the polygon and the plurality of survey lines based on the edge data structure; and generating waypoints on a path in the work area by assigning ordinal numbers to the intersections.

The generating of the edge data structure may include: aligning, in an alignment order, vertices of the polygon corresponding to corners of the work area based on coordinate values of the vertices of the polygon; and generating topology information of the edges based on the alignment order of the vertices.

The topology information may include an edge direction and an edge number.

A border of the survey area may be determined by maximum values and minimum values of first and second axes-coordinate values of vertices of the polygon.

The plurality of survey lines may be arranged in parallel to a first axis or a second axis of a coordinate system at an interval from one another corresponding to a work width in the survey area.

A survey line that is closest to a reference position of the survey area from among the plurality of survey lines may be at an interval corresponding to half the work width from the reference position.

The detecting of the intersections may include: detecting an intersection between a target edge from among the edges and a target survey line from among the plurality of survey lines; and changing the target edge or the target survey line according to whether the intersection between the target edge and the target survey line is detected or not.

The changing may include: when the intersection between the target edge and the target survey line is detected, changing the target survey line to a next survey line in an edge direction of the target edge; and when no intersection between the target edge and the target survey line is detected, changing the target edge to a next edge according to an edge number of the edge data structure.

A direction in which ordinal numbers are assigned to a plurality of intersections on one survey line may be alternately changed according to the survey lines.

According to an aspect of another exemplary embodiment, there is provided an apparatus for planning a path including: a processor to implement; a first configuration unit configured to generate an edge data structure of a polygon that represents a work area; a second configuration unit configured to generate a survey area including the polygon and generate a plurality of survey lines at a predetermined interval from one another in the survey area; and a third configuration unit configured to detect intersections between edges of the polygon and the plurality of survey lines based on the edge data structure and generate waypoints on a path in the work area by assigning ordinal numbers to the intersections.

The first configuration unit may be configured to align, in an alignment order, vertices of the polygon corresponding to corners of the work area based on coordinate values of the vertices and generate topology information of the edges based on the alignment order of the vertices.

The topology information may include an edge direction and an edge number.

A border of the survey area may be determined by maximum values and minimum values of first and second axes-coordinate values of vertices of the polygon.

The plurality of survey lines may be arranged in parallel to a first axis or a second axis of a coordinate system at an interval from one another corresponding to a work width in the survey area.

A survey line that is closest to a reference position of the survey area from among the plurality of survey lines may be at an interval corresponding to half the work width from the reference position.

The third configuration unit may be configured to detect an intersection between a target edge from among the edges and a target survey line from among the plurality of survey lines and change the target edge or the target survey line according to whether the intersection between the target edge and the target survey line is detected or not.

The third configuration unit, when the intersection between the target edge and the target survey line is detected, may be configured to change the target survey line to a next survey line in an edge direction of the target edge, and when no intersection between the target edge and the target survey line is detected, may be configured to change the target edge to a next edge according to an edge number of the edge data structure.

The third configuration unit may be configured to alternately change a direction in which ordinal numbers are assigned to a plurality of intersections on one survey line according to survey lines.

According to an aspect of another exemplary embodiment, there is provided a method of planning a path of a working device including: generating a polygon corresponding to a work area of the working device and generating an edge data structure based on the polygon; generating a survey area based on the polygon; generating a plurality of survey lines at a predetermined interval in the survey area; detecting at least one intersection between each of edges of the polygon and each of the plurality of survey lines based on the edge data structure; and generating the path of the working device in the work area based on the at least one intersection.

The generating the path may include generating waypoints along the path by assigning ordinal numbers to the at least one intersection; and connecting the waypoints in an ascending order or a descending order of the ordinal numbers.

The generating the edge data structure may include: assigning an alignment order to vertices of the polygon based on coordinate values of the vertices of the polygon; and generating topology information of the edges based on the alignment order of the vertices.

The topology information may include an edge direction of each edge and an edge number of each edge.

A border of the survey area may be determined by a maximum value and a minimum value of each of first and second axes-coordinate values of vertices of the polygon.

The plurality of survey lines may be arranged in parallel to a first axis or a second axis of a coordinate system at the predetermined interval corresponding to a work width of the working device performing a task in the survey area.

A survey line of the plurality of survey lines, which is closest to a reference position of the survey area from among the plurality of survey lines, may be at an interval corresponding to a half of the work width from the reference position.

The detecting the at least one intersection may include: detecting an intersection between a target edge from among the edges and a target survey line from among the plurality of survey lines; and changing the target edge or the target survey line based on the detecting the intersection between the target edge and the target survey line.

The changing the target edge or the target survey line may include: in response to the intersection between the target edge and the target survey line being detected, changing the target survey line to a next survey line from among the plurality of survey lines based on an edge direction of the target edge; and in response to no intersection between the target edge and the target survey line being detected, changing the target edge to a next edge from among the edges based on an edge number of the edge data structure.

According to an aspect of another exemplary embodiment, there is provided an apparatus for planning a path of a working device, including a hardware processor to implement: a first configuration unit configured to generate a polygon based on a work area of the working device and configured to generate an edge data structure based on the polygon; a second configuration unit configured to generate a survey area based on the polygon and configured to generate a plurality of survey lines at a predetermined interval in the survey area; and a third configuration unit configured to detect at least one intersection between each of edge of the polygon and each of the plurality of survey lines based on the edge data structure and generate the path of the working device in the work area based on the at least one intersection.

The first configuration unit may be configured to assign an alignment order to vertices of the polygon based on coordinate values of the vertices and configured to generate topology information of the edges based on the alignment order of the vertices.

The topology information may include an edge direction of each edge and an edge number of each edge.

The third configuration unit may be configured to detect an intersection between a target edge from among the edges and a target survey line from among the plurality of survey lines and to change the target edge or the target survey line based on the detecting the intersection between the target edge and the target survey line.

The third configuration unit may be configured to: in response to the intersection between the target edge and the target survey line being detected, to change the target survey line to a next survey line from among the plurality of survey lines based on an edge direction of the target edge, and in response to no intersection between the target edge and the target survey line being detected, to change the target edge to a next edge from among the edges based on an edge number of the edge data structure.

The third configuration unit is configured to generate waypoints along the path by assigning ordinal numbers to the at least one intersection; and configured to connect the waypoints in an ascending order or a descending order of the ordinal numbers.

According to an aspect of another exemplary embodiment, there is provided a method of planning a path of a working device for performing a task in a work area, the method including: generating a polygon based on the work area and generating an edge data structure based on the polygon, the edge data structure including: a plurality of vertices; and a plurality of edges connecting the plurality of vertices to form a border of the polygon; generating a survey area surrounding the border of the polygon; generating a plurality of survey lines at a predetermined interval in the survey area to intersect the plurality of edges of the polygon; detecting intersections of the plurality of edges and the plurality of survey lines based on the edge data structure and generating a waypoint at each intersection; and generating the path of the working device in the work area by connecting the waypoints at the intersections in a predetermined order.

According to an aspect of another exemplary embodiment, there is provided a non-transitory computer-readable recording medium has embodied thereon a program for executing the method described above.

### BRIEF DESCRIPTION OF THE DRAWINGS

The above and/or other aspects the disclosure will become apparent and more readily appreciated from the following description of the exemplary embodiments, taken in conjunction with the accompanying drawings in which:

FIG. 1 is a block diagram of an apparatus for planning a path according to an exemplary embodiment;

FIGS. 2 through 13 are diagrams for explaining method of determining a work path of the apparatus according to an exemplary embodiment;

FIGS. 14A and 14B are diagrams illustrating a work path determined when a concave area exists in a work area according to an exemplary embodiment;

FIGS. 15A through 15F are diagrams illustrating determined work paths according to an exemplary embodiment;

FIG. 16 is a flowchart of a method of determining a path according to an exemplary embodiment;

FIG. 17 is a diagram for explaining a method of determining a work path according to an exemplary embodiment; and

FIG. 18 is a flowchart of a method of determining a path according to an exemplary embodiment.

### DETAILED DESCRIPTION

As the inventive concept allows for various changes and numerous exemplary embodiments, the exemplary embodiments will be illustrated in the drawings and described in detail in the written description. However, this is not intended to limit the inventive concept to particular modes of practice, and it is to be appreciated that all changes, equivalents, and substitutes that do not depart from the spirit and technical scope of the inventive concept are encompassed in the inventive concept. In the description of the inventive concept, certain detailed explanations of the related art are omitted when it is deemed that they may unnecessarily obscure the essence of the inventive concept.

While such terms as “first”, “second”, etc., may be used to describe various components, such components must not be limited to the above terms. The above terms are used only to distinguish one component from another.

The terms used in the present specification are merely used to describe exemplary embodiments, and are not intended to limit the inventive concept. An expression used in the singular encompasses the expression of the plural, unless it has a clearly different meaning in the context. In the present specification, it is to be understood that the terms such as “including”, “having”, and “comprising” are intended to indicate the existence of the features, numbers, steps, actions, components, parts, or combinations thereof disclosed in the specification, and are not intended to preclude the possibility that one or more other features, numbers, steps, actions, components, parts, or combinations thereof may exist or may be added.

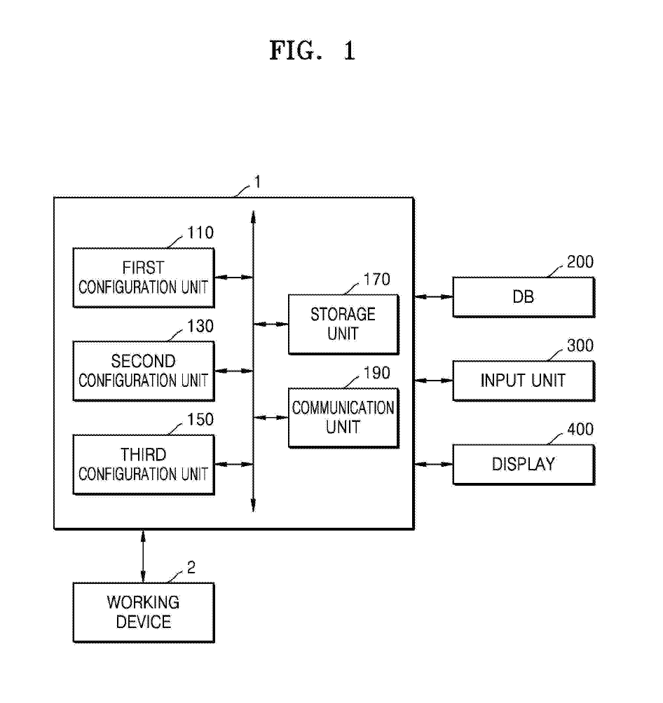

The inventive concept may be described in terms of functional block components as shown in FIG. 1, for example, and various processing steps. Such functional blocks may be realized by any number of hardware and/or software components configured to perform the specified functions. For example, the functional block components may employ various integrated circuit (IC) components, e.g., memory elements, processing elements, logic elements, look-up tables, and the like, which may carry out a variety of functions under the control of one or more microprocessors or other control devices included therein or connected thereto. Similarly, where the elements of the inventive concept are implemented using software programming or software elements, the inventive concept may be implemented with any programming or scripting language such as C, C++, Java, assembler language, or the like, with the various algorithms being implemented with any combination of data structures, objects, processes, routines or other programming elements. Functional aspects may be implemented in algorithms that are executed on one or more processors. Furthermore, the inventive concept could employ any number of conventional techniques for electronics configuration, signal processing and/or control, data processing and the like. The words “mechanism”, “element”, “means”, and “configuration” are used broadly and are not limited to mechanical or physical exemplary embodiments, but can include software routines in conjunction with processors, etc.

As used herein, the term “and/or” includes any and all combinations of one or more of the associated listed items. Expressions such as “at least one of” when preceding a list of elements, modify the entire list of elements and do not modify the individual elements of the list.

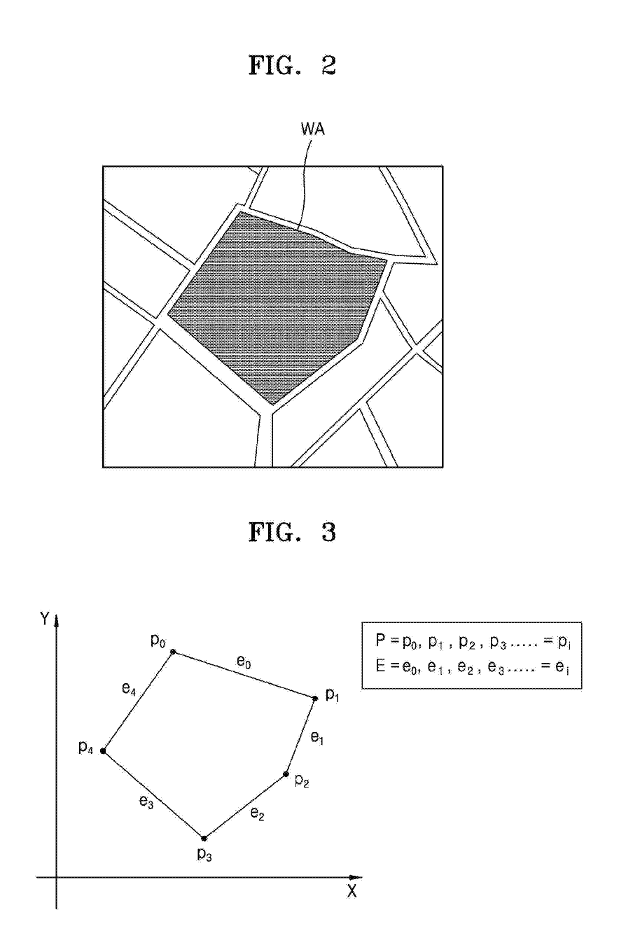

FIG. 1 is a block diagram of an apparatus 1 for planning a path according to an exemplary embodiment. FIGS. 2 through 13 are diagrams for explaining a method of planning a travel path of the apparatus 1 according to an exemplary embodiment.

The apparatus 1 may correspond to at least one processor or the apparatus 1 may include at least one processor. The apparatus 1 may be included in another hardware apparatus such as a general-purpose computer system or a microprocessor and may be driven. The apparatus 1 may correspond to a processor included in a working device 2. Alternatively, as shown in FIG. 1, the apparatus 1 according to an exemplary embodiment may be connected to the working device 2 by wire or wirelessly.

The working device 2 may be a transportation means for performing a task in a work area WA (FIG. 2) on the ground or in the air. According to an exemplary embodiment, the working device 2 may be an agricultural or industrial machine, a robot, a vehicle, or an aircraft. The working device 2 may be a manned device having a crew or an unmanned device having no crew. The working device 2 may be connected to the apparatus 1 through a wireless communication network. In this case, the wireless communication network may be any of various networks using various frequency bands such as code division multiple access (CDMA), WiFi, wireless broadband (WIBro), or long-term evolution (LTE).

When the working device 2 determines a path for optimally performing a task in a work area WA, waypoints are important. The apparatus 1 generates optimal waypoints on a travel path of the working device 2. The apparatus 1 may include a first configuration unit 110, a second configuration unit 130, a third configuration unit 150, a storage unit 170, and a communication unit 190.

The first configuration unit 110 may generate an object of a polygon in order to express a work area WA as a geometric element and may generate a data structure (hereinafter, referred to as an ‘edge data structure’) of edges (or sides) of the polygon based on coordinates of points constituting the polygon. The polygon may include vertices that represent the polygon and the edges that connect the vertices. The edge data structure may include topology information of elements (i.e., the vertices and the edges) that constitute the polygon. The topology information may include an edge direction and an edge number.

The first configuration unit 110 may rotate a coordinate system by considering a gradient of a direction of a path according to an environment element to obtain a rotated coordinate system and may change coordinates of the polygon based on coordinate axes of the rotated coordinate system.

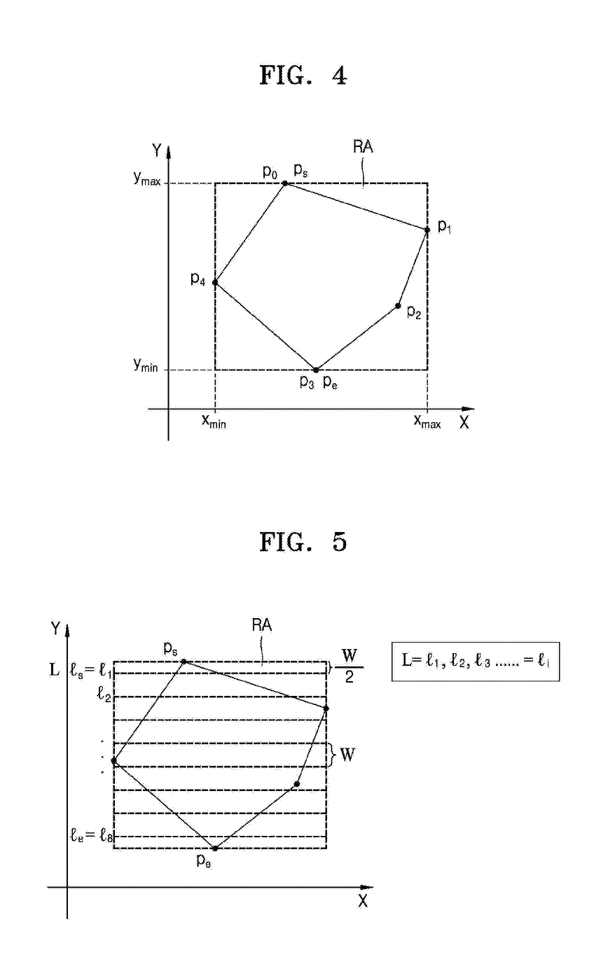

The second configuration unit 130 may generate a survey area RA (FIG. 4) including the polygon and may generate a plurality of survey lines at an interval corresponding to a work width of the working device 2 in the survey area RA. The survey lines may be arranged in parallel to a first axis (e.g., x-axis) or a second axis (e.g., y-axis) of a two-dimensional (2D) coordinate system.

The third configuration unit 150 may detect intersections between the edges and the survey lines based on the edge data structure. The third configuration unit 150 may select a target edge according to the edge number and may select a target survey line in the survey area RA according to the edge direction. The third configuration unit 150 may detect an intersection between the target survey line and the target edge. The third configuration unit 150 may generate waypoints by assigning ordinal numbers to the detected intersections.

The working device 2 may receive waypoint information from the apparatus 1 and may travel along the waypoints. The working device 2 may travel shortest distances (e.g., straight lines) between the waypoints.

The apparatus 1 according to an exemplary embodiment may generate the waypoints irrespective of a shape of the polygon of which path is to be calculated and a change in a gradient of the path. The apparatus 1 may generate the waypoints by pre-processing the edges of the polygon into an efficient data structure including order information and repeatedly performing a simple process of calculating intersections between straight lines.

The storage unit 170 may store work area information, edge information, the waypoint information, and path information. The storage unit 170 may include at least one type of storage medium from among a flash memory type-memory, a hard disk type-memory, a multimedia card micro-type memory, a card-type memory (e.g. SD or XD memory), a random-access memory (RAM), and a read-only memory (ROM).

The communication unit 190 may transmit/receive data between the apparatus 1 and an external data processing system or apparatus. The communication unit 190 may transmit/receive data through a wired communication link and/or a wireless communication link. The communication unit 190 may include a communication module that may use Wi-Fi, radio communication, Bluetooth, or any appropriate communication technology.

The apparatus 1 may be connected to a database 200, an input unit 300, and a display 400 by wire or wirelessly and may transmit/receive data to/from the database 200, the input unit 300, and the display 400. The apparatus 1 may interoperate with the database 200, the input unit 300, and the display 400.

The database 200 may include a map database. The database 200 may obtain and store an aerial photograph or a map of the work area WA and may update the aerial photograph or the map of the work area WA in real time.

The input unit 300 may be a user interface such as a keypad, a dome switch, a touchpad (e.g., a contact capacitive type, a pressure resistance type, an infrared sensing type, a surface ultrasonic wave conduction type, an integral tension measurement type, or a piezoelectric effect type), a mouse, a remote controller, a jog wheel, or a jog switch. A user may set the work area WA by directly inputting a position (coordinates) of the work area WA through the input unit 300 or selecting an area on the map output on the display 400.

The display 400 may provide an image output from the apparatus 1 to the user so that the user may monitor the image. The display 400 may provide a series of processes for generating the waypoints and the map for setting the work area WA to the user. The display 400 may provide visual information and/or auditory information to the user. The display 400 may be a computer screen, a TV screen, a mobile terminal screen, or a projector. When the display 400 is a touchscreen, the touchscreen may operate as the input unit 300.

An operation of the apparatus 1 will now be explained in detail with reference to FIGS. 2 through 13.

Referring to FIG. 2, the communication unit 190 may receive information about a work area WA and may transmit the information to the first configuration unit 110. The first configuration unit 110 may receive the information of the work area WA that is directly input by the user or that is selected by the user on a map output from the database 200. The work area WA may be an area that is defined by a plurality of corners and boundary lines between the corners.

Referring to FIG. 3, the first configuration unit 110 may generate a polygon that represents the work area WA based on the information of the work area WA. The polygon may include vertices P (noted as pᵢ) corresponding to the corners of the work area WA and edges E (noted as eᵢ) corresponding to the boundary lines of the work area WA where each edge eᵢ connects adjacent vertices P. The polygon representing the work area WA may be generated in an XY coordinate system. An origin of the XY coordinate system may be at a specific position on the map.

The first configuration unit 110 may align the vertices P of the polygon. The vertices P may be expressed as a set as follows. The number of the vertices P of the polygon is at least three (3).

P={pi|pi=(x, y), i=0, 1, 2, . . . , n}

The first configuration unit 110 may set an arbitrary vertex as a reference point and may align the vertices P in a clockwise or counterclockwise direction based on coordinate values of the vertices P from a reference point (from one of the vertices P). The reference point may be arbitrarily selected, or a vertex of which x or y-coordinate value is the largest may be selected as the reference point. For example, the first configuration unit 110 may sequentially align vertices p₀, p₁, P₂, p₃, and p₄ in a clockwise direction from the vertex P₀ or may sequentially align the vertices p₂, p₁, P₀, p₄, p₃ in a counterclockwise direction from the vertex p₁. The following will be explained on the assumption that the vertices P are aligned by using the vertex P₀ of which the y-coordinate value is the largest as a reference point.

The first configuration unit 110 may generate an edge data structure based on coordinate values of the aligned vertices P. Each edge eᵢ may have two adjacent vertices (e.g., P₀ and p₄) as a start point and an end point. The edges E may be expressed as a set as follows. The number of the edges E is at least three (3).

E={eᵢ|eᵢ=(pi, pᵢ₊₁), i=0, 1,2, . . . ,n}
e₀=p₀p₁, e₁=p₁p₂, e₂=p₂p₃, e₃=p₃p₄, e₄=p₄p₀

The edge data structure may include topology information of the edges E. The topology information may include an edge direction and an edge number of each edge. The edge direction may be defined as a direction from a start point toward an end point of the edge. The edge number may be determined according to an order in which the vertices P are aligned. The edge number may be set by using an edge, which has a reference point, e.g., the vertex p₀, as a start point, as a first edge e₀ in a clockwise direction or a counterclockwise direction.

Referring to FIG. 4, the second configuration unit 130 may generate a survey area RA including the polygon. The survey area RA may be determined by maximum values and minimum values of each of x and y-coordinate values of the vertices P of the polygon. The survey area RA may have a quadrangular shape including, as sides, segments that are parallel to the y-axis and pass through a minimum coordinate value, xₘᵢₙ, and a maximum coordinate value, xₘₐₓ, of the x-axis and segments that are parallel to the x-axis and pass through a minimum coordinate value, yₘᵢₙ, and a maximum coordinate value, yₘₐₓ, of the y-axis.

yₘᵢₙ=min pᵢ(y), yₘₐₓ=max pᵢ(y); and xₘᵢₙ=min pᵢ(x), xₘₐₓ=max pᵢ(x)

The survey area RA passes through the vertices p₄ and p₁ respectively having the minimum coordinate value, xₘᵢₙ, and the maximum coordinate value, xₘₐₓ, of the x-axis and the vertices p₀ and p₃ respectively having the minimum coordinate value, yₘᵢₙ, and the maximum coordinate value, yₘₐₓ, of the y-axis. A vertex having the minimum coordinate value, yₘᵢₙ, of the y-axis is referred to as an end vertex pₑ and a vertex having the maximum coordinate value, yₘₐₓ, of the y-axis is referred to as a start vertex pₛ.

Referring to FIG. 5, the second configuration unit 130 may generate a plurality of survey lines L (noted as lᵢ) in the survey area RA. The survey lines L may be parallel to the x-axis or the y-axis and may be arranged at an interval W corresponding to a work width of the working device 2. In FIG. 5, the survey lines L are arranged in parallel to the x-axis. The survey lines L are located only in the survey area RA. One of the survey lines L may be matched to one side of the survey area RA. A first survey line I₁ that is a start survey line Iₛ is spaced apart by a half the interval W from a reference position, for example, a top side (i.e., a line passing the yₘₐₓ), of the survey area RA. The survey lines L from the first survey line I₁ or Iₛ to a last survey line Iₑ are spaced by the interval W. A y-coordinate value Iᵢ(y) of each survey line may be expressed as follows. The last survey line Iₑ may be matched to a bottom side (i.e., a line passing the yₘᵢₙ) of the survey area RA, or may have a y-coordinate value that is greater than that of the bottom side. That is, the y-coordinate of the last survey line Iₑ may be equal to or greater than a y-coordinate value of the end vertex pₑ.

$${I}_{s} ( y ) = {I}_{1} ( y ) = {p}_{s} ( y ) - ( W / 2 )$$

$${I}_{2} ( y ) = {I}_{s} ( y ) - W$$

$${I}_{3} ( y ) = {I}_{2} ( y ) - W$$

$$…$$

$${I}_{e} ( y ) = {I}_{e} - I ( y ) - W \geq {p}_{e} ( y )$$

The number of the survey lines L may be determined by a height of the survey area RA and the interval W.

The work width corresponds to a width of the work being performed by the working device 2 as the work device 2 moves along a work path (the work width extends substantially perpendicular to the work path of the working device 2). For example, when the working device 2 is an aircraft which performs a pest control work be spreading a pest control agent, the work width corresponds to a range in which the pest control agent is sprayed. As another example, when the working device 2 is a machine which performs a task on the ground (e.g., mowing or harvesting), the work width may corresponds to a width of the mowing or the harvesting being performed by the working device 2 as the working device 2 moves along the work path. As another example, when the working device 2 is an aircraft which obtains an image using a camera, the work width corresponds to a viewing width of the camera (perpendicular to the path of the aircraft). The work width may be set so that adjacent/successive work widths slightly overlap each other.

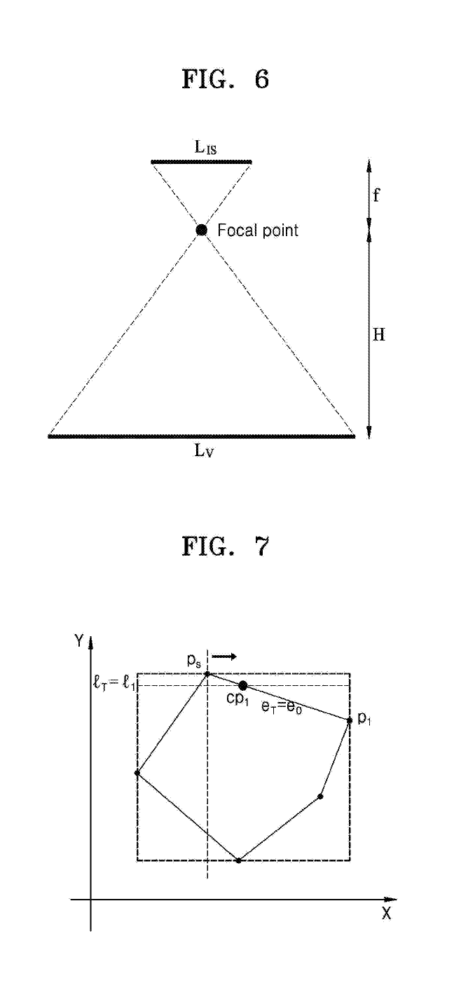

FIG. 6 is a diagram for explaining a viewing width L_{V} of a camera. Referring to FIG. 6, the viewing width Lᵥ of the camera may be calculated by using a width L_{IS} of an image sensor, a focal point f of a lens, and a flight height H that is a distance between the camera and the ground. Here, the viewing width L_{V} of the camera may correspond to the working width.

L_{V}=H*(L_{IS}/f)

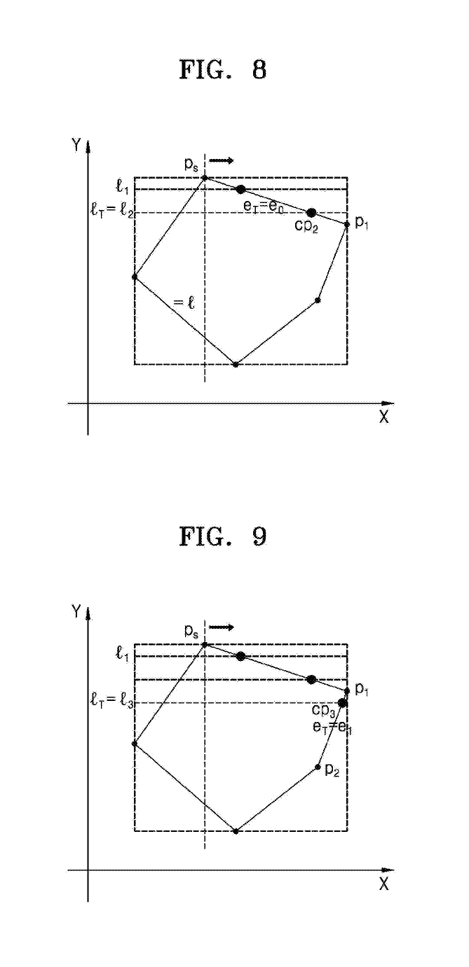

Referring to FIGS. 7 through 13, the third configuration unit 150 may detect intersections between the edges E and the survey lines L. The third configuration unit 150 may detect an intersection between each edge eᵢ and at least one survey line Iᵢ according to an edge number. An edge and a survey line, of which an intersection between the edge and the survey line is to be detected by the third configuration unit 150, are respectively referred to as a target edge e_{T} and a target survey line I_{T}.

The third configuration unit 150 may detect an intersection between the target edge e_{T} and the target survey line I_{T}. The third configuration unit 150 may change the target edge e_{T} of the edges E or the target survey line I_{T} of the survey lines L according to whether there is an intersection between the target edge e_{T} and the target survey line I_{T}. When there is an intersection between the target edge e_{T} and the target survey line I_{T}, the third configuration unit 150 changes the target survey line I_{T}. A change direction of the target survey line I_{T} may be an edge direction of the target edge e_{T}. On the other hand, when there is no intersection between the target edge e_{T} and the target survey line I_{T}, the third configuration unit 150 changes the target edge e_{T}. A change direction of the target edge e_{T} may follow an edge number, for example.

For example, when there is an intersection between the target edge e_{T} and the target survey line I_{T}, the third configuration unit 150 may set a next survey line according to the edge direction of the target edge e_{T} as a target survey line I_{T} and may detect an intersection between the target survey line I_{T} and the target edge e_{T}. When there is no intersection between the target edge e_{T} and the target survey line I_{T}, the third configuration unit 150 may set a next edge according to the edge number as a target edge e_{T} and may detect an intersection between the target edge e_{T} and the target survey line I_{T}.

Because the third configuration unit 150 detects an intersection by comparing one target edge with one survey line, a risk of an edge error may be reduced and a calculation for detecting an intersection may be simplified.

As shown in FIG. 7, the third configuration unit 150 may detect an intersection between an edge (e.g., the first edge e₀) corresponding to the target edge e_{T} and a survey line (e.g., the first survey line I₁) corresponding to the target survey line I_{T}.

Because there is an intersection cp₁ between the first edge e₀ and the first survey line I₁, as shown in FIG. 8, the third configuration unit 150 may change the second survey line I₂ as the target survey line I_{T} from the first survey line I₁ and may detect an intersection between the second survey line I₂ and the first edge e₀. Because an edge direction of the first edge e₀ is from top to bottom, a change direction of the target survey line I_{T} is from top to bottom.

Because there is an intersection cp₂ between the first edge e₀ and the second survey line I₂, as shown in FIG. 9, the third configuration unit 150 may change the third survey line I₃ as the target survey line I_{T} and may detect an intersection between the third survey line I₃ and the first edge e₀.

Because there is no intersection between the first edge e₀ and the third survey line I₃, the third configuration unit 150 may change the second edge e₁ as the target edge e_{T} from the first edge e₀ and may detect an intersection between the second edge e₁ and the third survey line I₃. A movement direction of the target edge e_{T} may be a clockwise direction or a counterclockwise direction. In FIG. 9, the movement direction of the target edge e_{T} is a clockwise direction.

Because there is an intersection cp₃ between the second edge e₁ and the third survey line I₃, the third configuration unit 150 may change the fourth survey line I₄ as the target survey line I_{T} from the third survey line I₃ and may detect an intersection between the fourth survey line I₄ and the second edge e₁.

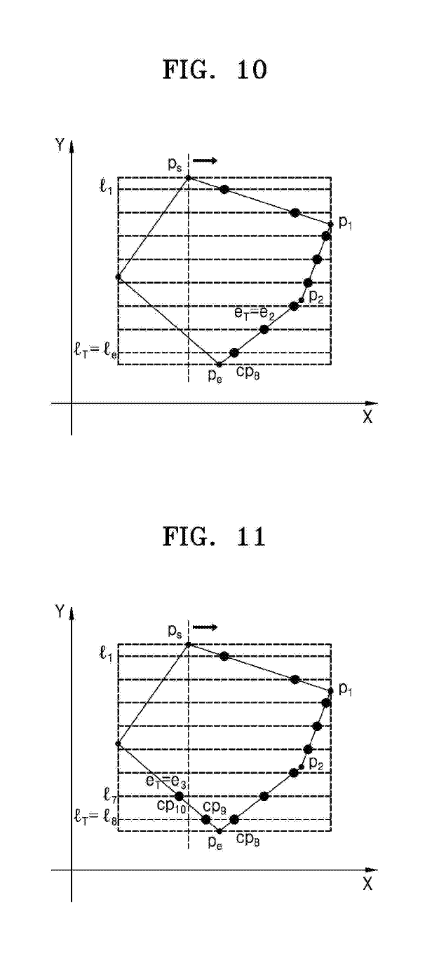

As shown in FIG. 10, the third configuration unit 150 may continuously detect an intersection by changing the target edge e_{T} and the target survey line I_{T} in the clockwise direction until the end vertex pₑ is reached.

When the target survey line I_{T} is the last survey line Iₑ that is close to the end vertex pₑ (not having a y-value which is smaller than the yₘᵢₙ), the third configuration unit 150 ends a process of detecting an intersection with the target edge e_{T} (the third edge e2) and changes the target edge e_{T} to the fourth edge e₃. An edge direction is from bottom to top based on the end vertex pₑ.

As shown in FIG. 11, because an intersection cp₉ between the fourth edge e₃ and the last survey line Iₑ is detected, the third configuration unit 150 changes the target survey line I_{T}. Because an edge direction of the fourth edge e₃ is from bottom to top, a change direction of the target survey line I_{T} is from bottom to top. The third configuration unit 150 may detect an intersection cp₁₀ between the fourth edge e₃ and a survey line Iₑ₋₁ (e.g., I₇ in FIG.11) that is right above the last survey line Iₑ as the target survey line I_{T}.

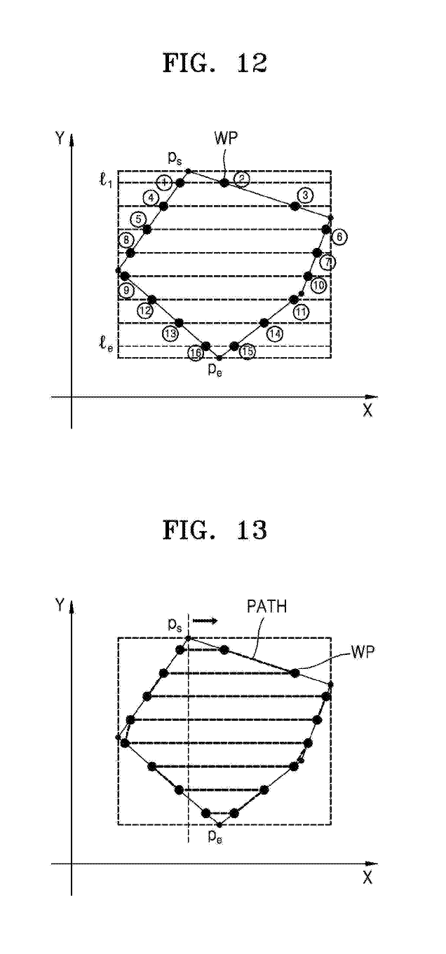

Referring to FIG. 12, the third configuration unit 150 may complete a process of detecting an intersection with the last edge e₄. Because one survey line passes through two edges, two intersections may be detected on each survey line.

When intersections of the edges E included in the survey area RA are completely detected, the third configuration unit 150 may assign ordinal numbers to the intersections according to a set rule and may generate waypoints WP. The waypoints WP are points on a path that covers the work area.

With respect to determining a start intersection corresponding to a start point of a work path for a working device 2, start intersection candidates are intersections on the first survey line I_{I} and the last survey line Iₑ. For example, the third configuration unit 150 may set, a start intersection, an intersection (between an edge and a survey line) that is the closest to a work standby position of the working device 2 from among the start intersection candidates. The third configuration unit 150 aligns intersections on each survey line in a y-coordinate value order, that is, a descending order of y-coordinates values. Alternatively, the third configuration unit 150 may align a plurality of intersections on one survey line based on an x-coordinate value order. The third configuration unit 150 alternately changes an intersection alignment order between an ascending order and a descending order of x-coordinate values according to survey lines.

In FIG. 12, the third configuration unit 150 sets a left intersection from among intersections on the first survey line I₁ as a start intersection and aligns intersections in a descending order of y-coordinate values, and aligns intersections on odd-numbered survey lines are aligned in an ascending order of x-coordinate values and intersections on even-numbered survey lines are aligned in a descending order of x-coordinate values. For example, the third configuration unit 150 may align intersections on the first survey line I₁ in an ascending order of x-coordinate values and may align intersections on the second survey line I₂ in a descending order of x-coordinate values. The third configuration unit 150 may sequentially assign ordinal numbers to the aligned intersections and may generate waypoints WP. Referring to FIG. 12, the waypoints WP are numbered from 1 through 16.

Referring to FIG. 13, the working device 2 may receive waypoint information and travel along a path PATH that follows the waypoints WP (from 1 through 16). The working device 2 may perform a work along straight lines that connect waypoints WP in an ascending order (e.g., from 1 to 2, 2 to 3, 3 to 4, etc.).

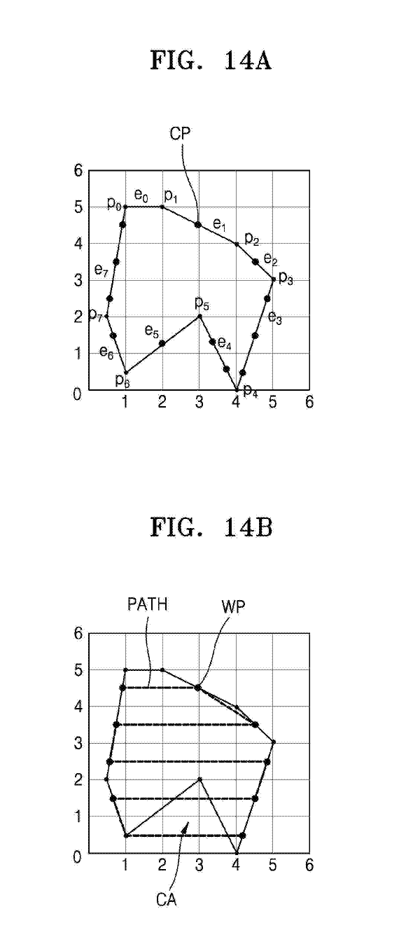

FIGS. 14A and 14B are diagrams illustrating a path PATH generated when there is a concave area CA in a work area WA according to an exemplary embodiment. FIG. 14A illustrates intersections detected in the work area WA including the concave area CA according to an exemplary embodiment. FIG. 14B is a diagram illustrating waypoints WP generated on the path PATH.

A shape of a polygon may be a convex shape or a concave shape. According to an exemplary embodiment, the waypoints WP may be generated irrespective of the shape of the polygon.

As shown in FIG. 14A, an apparatus 1 for planning a path may detect an intersection cp between survey lines and edges e₄=p₄p₅ and e₅=p₅p₆ included in the concave area CA. In FIG. 14A, four intersections are detected on a survey line through which four edges pass and three intersections are detected on a survey line through which a point pₑ=p₆ passes.

As shown in FIG. 14B, the apparatus 1 may generate the waypoints WP by sequentially assigning ordinal numbers to intersections according to the above-described intersection alignment rule. When three or more intersections are detected on a survey line, the apparatus 1 may select two intersections whose x-coordinate values are a maximum value and a minimum value as the waypoints WP. The apparatus 1 may travel a work path PATH that is a shortest distance straightly connecting the waypoints WP.

The apparatus 1 may store, in the storage unit 170, path information including the work path PATH and/or the waypoints WP determined by the third configuration unit 150. The apparatus 1 may transmit the path information to the working device 2 through the communication unit 190.

The working device 2 may move from a standby position to a work start position (i.e., a start waypoint or a start intersection), and may perform a task along the work path PATH by passing through the ascending/descending waypoints WP from the work start point to a work end position (i.e., an end waypoint or an end intersection). The working device 2 may receive only waypoint information from among the path information from the apparatus 1. The waypoint information may include coordinates of the start waypoint and the end waypoint and coordinates of waypoints between the start waypoint and the end waypoint. The working device 2 may perform a task by traveling in straight lines between the successive waypoints.

The working device 2 may further receive intersection information (e.g., coordinates) detected in the concave area CA of FIGS. 14A and 14B from the apparatus 1. The working device 2 may be set to stop a work while passing between intersections of the concave area CA (i.e., while following the work path PATH). For example, an aircraft which has a task of monitoring the work area WA may turn off a camera while flying over the concave area CA.

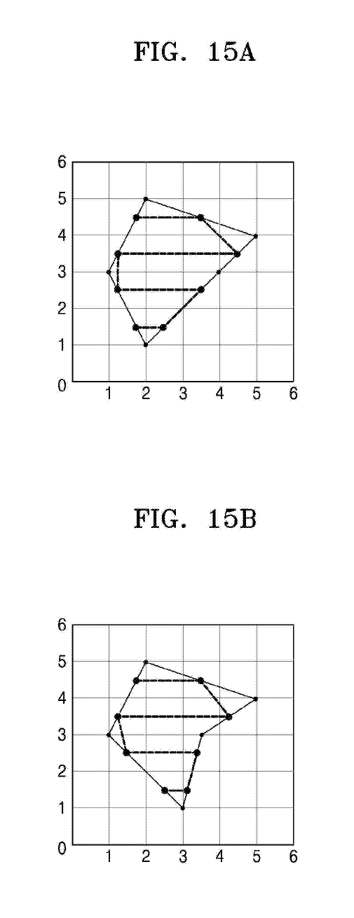

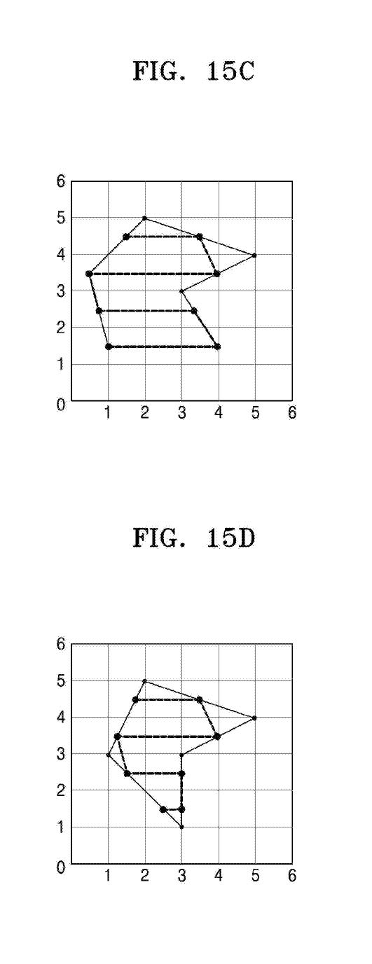

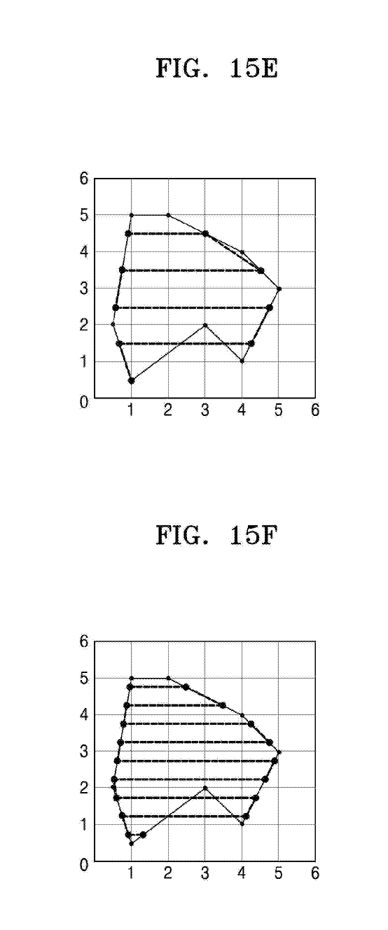

FIGS. 15A through 15F are diagrams illustrating determined work paths according to an exemplary embodiment.

The apparatus 1 according to an exemplary embodiment may determine a work path irrespective of a shape of a work area, for example, irrespective of whether the work area is represented by a convex polygon (FIG. 15A), the work area is represented by a concave polygon (FIG. 15B), the work area is represented by a polygon including an edge parallel to the x-axis (FIG. 15C), or the work area is represented by a polygon including an edge parallel to the y-axis (FIG. 15D).

Also, the apparatus 1 according to an exemplary embodiment may determine a work path irrespective of a work width, for example, irrespective of whether the work width of the working device 2 is large (FIG. 15E) or the work width of the working device 2 is small (FIG. 15F).

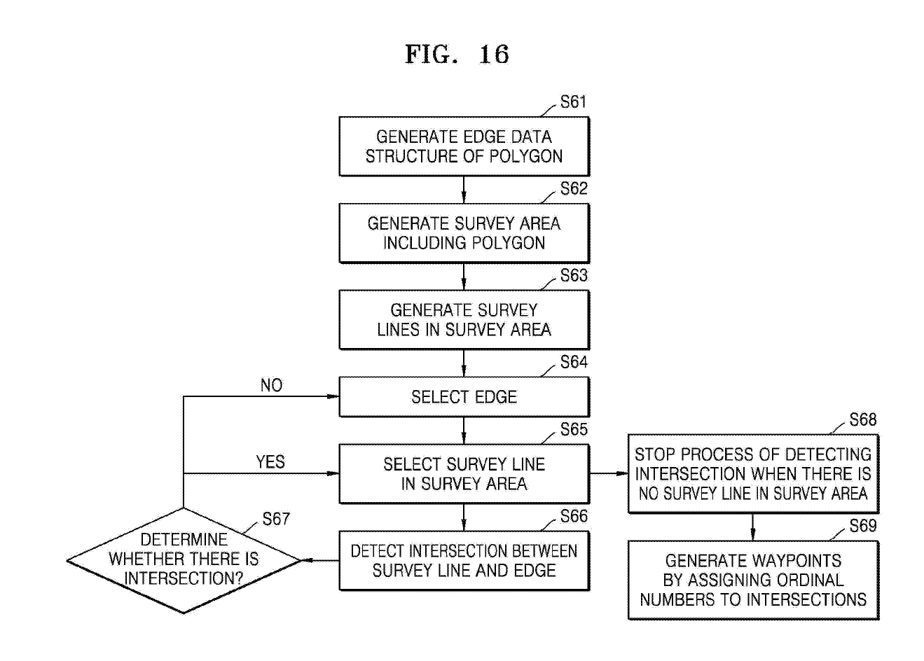

FIG. 16 is a flowchart for explaining a method of planning a path according to an exemplary embodiment. The method of FIG. 16 may be performed by the apparatus 1 of FIG. 1, and the same description as that made with reference to FIGS. 1 through 15 will not be given.

Referring to FIG. 16, in operation S61, the apparatus 1 may generate an edge data structure of a polygon that represents a work area WA. The polygon may include vertices corresponding to corners of the work area WA and edges corresponding to boundary lines which connect the vertices. The apparatus 1 may align/arrange the vertices of the polygon in a clockwise direction or a counterclockwise direction from a reference point (from one of the vertices). The reference point may correspond to a vertex of the polygon of which x or y-coordinate value (the y-coordinate value of a starting vertex pₛ in an exemplary embodiment of FIG. 4) is the largest.

The apparatus 1 may generate an edge data structure based on coordinates of the aligned vertices P. The edge data structure may include topology information including an edge direction and an edge number of each edge eᵢ. The edge direction may be a direction from a start point toward an end point of the edge eᵢ. The edge number may be set in a clockwise direction or a counterclockwise direction according to an order of points of the polygon.

In operation S62, the apparatus 1 may generate a survey area RA including the polygon. The survey area RA may have a quadrangular shape including, as sides, segments that are parallel to the y-axis and pass through a minimum coordinate value and a maximum coordinate value of the x-axis and segments that are parallel to the x-axis and pass through a minimum coordinate value and a maximum coordinate value of the y-axis from among the points of the polygon.

In operation S63, the apparatus 1 may generate a plurality of survey lines L at an interval corresponding to a work width W of a working device 2 in the survey area. The survey lines may be parallel to the x-axis. A start survey line I₁ is spaced by half the interval (W/2) corresponding to the work width from a top side of the survey area RA. The survey lines L from the start survey line to a last survey line are spaced by the interval corresponding to the work width.

The apparatus 1 may detect a plurality of intersections between the edges E and the survey lines L. In operation S64, the apparatus 1 may select a target edge according to an edge number. In operation S65, the apparatus 1 may select a target survey line in the survey area. In operation S66, the apparatus 1 may detect an intersection between the target survey line and the target edge.

In operation S67, it is determined whether there is the intersection between the target survey line and the target edge. When it is determined in operation S67 that there is the intersection between the target survey line and the target edge, the apparatus 1 may return to operation S65 and may re-select a target survey line. A change direction of the target survey line may be a direction of the target edge. When the direction of the target edge is from top to bottom along the y-axis, the change direction of the target survey line may be set to be from top to bottom. When the direction of the target edge is from bottom to top along the y-axis, the change direction of the target survey line may be set to be from bottom to top.

When it is determined in operation S67 that there is no intersection between the target survey line and the target edge, the apparatus 1 may return to operation S64 and may re-select a target edge. A change direction of the target edge may follow an edge number, that is, a clockwise direction or a counterclockwise direction.

In operation S68, the apparatus 1 may end a process of detecting an intersection when the target survey line for a last edge is no longer located in the survey area.

In operation S69, the apparatus 1 may determine an order of the intersections according to an intersection alignment rule and may generate waypoints.

The apparatus 1 may transmit path information including waypoint information and/or work path information to the working device.

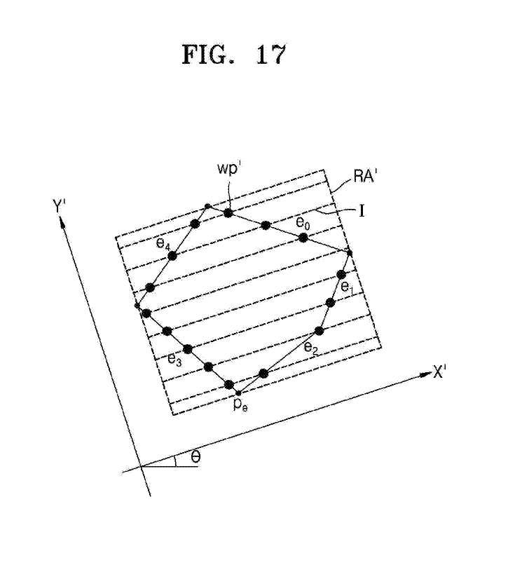

FIG. 17 is a diagram for explaining a method of determining a work path according to an exemplary embodiment.

Because a work environment varies according to a weather condition such as a wind direction and/or a wind velocity, it may be necessary to determine a work path of the working device 2 in consideration of the work environment. The apparatus 1 of FIG, 1 may obtain state information of the work environment and may calculate a gradient change (e.g., a rotation angle θ) of the work path based on the state information and travel information (e.g., a travel speed, a travel altitude, or a travel direction) of the working device 2. The apparatus 1 may obtain the state information from sensors (e.g., an anemoscope and an anemometer) provided in a work area.

The apparatus 1 may change an x-y coordinate system to an x′-y′ coordinate system by rotating the x-y coordinate system by the gradient change (e.g., the rotation angle). The apparatus 1 may change coordinate values of points of a polygon in the x-y coordinate system to coordinate values in the x′-y′ coordinate system.

The apparatus 1 may generate a survey area RA′ on the polygon of the x′y′ coordinate system, and may generate survey lines L, which are parallel to the x′-axis, in the survey area RA′.

The apparatus 1 may detect intersections between edges of the polygon and the survey lines L that are parallel to the x′-axis, and may generate waypoints wp′ by assigning ordinal numbers to the intersections. The apparatus 1 may change coordinate values of the waypoints wp' generated in the x′-y′ coordinate system to coordinate values in the x-y coordinate system before rotation.

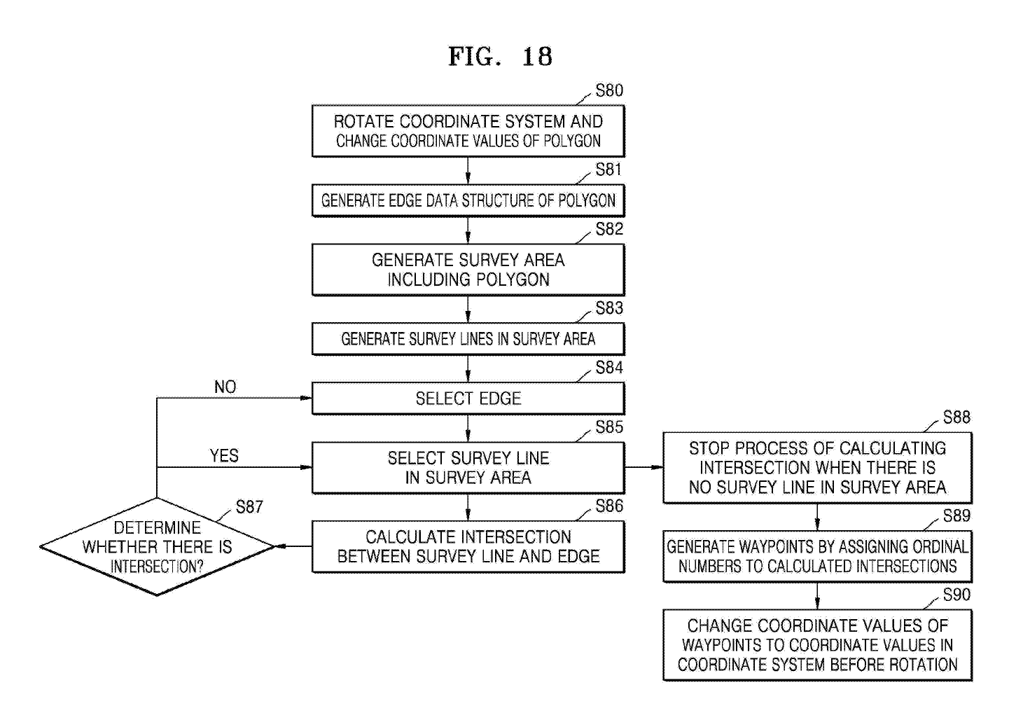

FIG. 18 is a flowchart for explaining a method of determining a path according to an exemplary embodiment. The method of FIG. 18 may be performed by the apparatus of FIG. 1, and the same description as that made with reference to FIGS. 1 through 17 will not be given.

Referring to FIG. 18, in operation S80, the apparatus 1 may change an x-y coordinate system to an x′-y′ coordinate system by rotating the x-y coordinate system by a rotation angle of a work path, and may change coordinate values of vertices of a polygon in the x-y coordinate system to coordinate values in the x′-y′ coordinate system.

In operation S81, the apparatus 1 may generate an edge data structure based on coordinate information of the vertices of the polygon that represents a work area in the x′-y′ coordinate system. The edge data structure may include topology information including an edge direction and an edge number of each edge.

In operation S82, the apparatus 1 may generate a survey area including the polygon.

In operation S83, the apparatus 1 may generate a plurality of survey lines at an interval corresponding to a work width in the survey area.

The apparatus 1 may detect a plurality of intersections between the edges and the survey lines. In operation S84, the apparatus 1 may select a target edge according to an edge number. In operation S85, the apparatus 1 may select a target survey line in the survey area. In operation S86, the apparatus 1 may detect an intersection between the target survey line and the target edge.

It is determined in operation S87 whether the intersection between the target survey line and the target edge is detected or not. When it is determined in operation S87 that the intersection between the target survey line and the target edge is detected, the apparatus 1 may return to operation S85 and may re-select a target survey line. A change direction of the target survey line may be a direction of the target edge.

When it is determined in operation S87 that no intersection is detected between the target survey line and the target edge, the apparatus 1 may return to operation S84 and may re-select a target edge. A change direction of the target edge may follow an edge number, that is, a clockwise direction or a counterclockwise direction.

In operation S88, the apparatus 1 may end a process of detecting an intersection when the target survey line for a last edge is no longer located in the survey area.

In operation S89, the apparatus 1 may determine an order of the intersections according to an intersection alignment rule and may generate waypoints.

In operation S90, the apparatus 1 may change coordinate values of the waypoints generated in the x′y′ coordinate system to coordinate values in the xy coordinate system before rotation.

The apparatus 1 may transmit path information including waypoint information and/or work path information to a working device.

Although intersections are detected by setting an edge number in a clockwise direction or a counterclockwise direction along the y-axis, the exemplary embodiments are not limited thereto. For example, intersections may be detected by setting an edge number in a clockwise direction or a counterclockwise direction along the x-axis by using a vertex of a polygon whose x-coordinate value is a smallest or a largest as a reference point. In an exemplary embodiment, a specific vertex may be used as a reference point, and intersections may be detected by setting an edge number at a left side of the reference point in a clockwise direction and an edge number at a right side of the reference point in a counterclockwise direction.

In the exemplary embodiments, because optimal waypoints are detected in consideration of a point set on a 2D plane that constitutes a polygon, an interval of a path, and a gradient of the path, the path may be efficiently calculated. Also, in exemplary embodiments, because a direction in which intersections are detected is determined according to directions of edges of the polygon and survey lines, the direction is intuitively determined, a calculation for determining the direction is not required, and the direction is determined irrespective of a shape of the polygon.

A method of determining a work path according to an exemplary embodiment may be applied to any transportation means and may be used to suggest a path to a driver in a manual travel mode and to suggest an automatic travel path in an unmanned travel mode. Also, the method according to an exemplary embodiment may be used to designate a work path of equipment or various robots used in industrial applications as well as transportation means. That is, the method may be applied to various fields that may use any path including a designated area without restrictions.

Exemplary embodiments may be used to determine an automatic path for circulating a specific area of a working device or spraying agricultural chemicals, a path for making a three-dimensional (3D) map by collecting images, a path for detecting a defect of a solar panel, and an efficient path for observing, monitoring, or patrolling a designated area.

For example, exemplary embodiments may be used as a method that enables an unmanned aerial vehicle (UAV) to fly over an area along an automatic path. When information about the whole area is to be obtained or when the UAV has a task that has to be uniformly performed over the area, the method may be effectively used.

According to the one or more exemplary embodiments, an efficient travel path that may include a specific area desired by an operator of a transportation means may be provided.

The inventive concept may also be embodied as computer-readable codes on a computer-readable recording medium. The computer-readable recording medium is any data storage device that may store data which can thereafter be read by a computer system. Examples of the computer-readable recording medium include read-only memories (ROMs), random-access memories (RAMs), CD-ROMs, magnetic tapes, floppy disks, and optical data storage devices. The computer-readable recording medium may also be distributed over network coupled computer systems so that the computer-readable code is stored and executed in a distributive manner. Also, functional programs, codes, and code segments for accomplishing the inventive concept may be easily construed by programmers skilled in the art to which the inventive concept pertains.

While the inventive concept has been particularly shown and described with reference to exemplary embodiments thereof, it will be understood by one of ordinary skill in the art that various changes in form and details may be made therein without departing from the spirit and scope of the inventive concept as defined by the following claims.

What is claimed is:

1. A method of planning a path of a working device, the method comprising:
generating a polygon corresponding to a work area of the working device and generating an edge data structure based on the polygon;
generating a survey area based on the polygon;
generating a plurality of survey lines at a predetermined interval in the survey area;
detecting at least one intersection between each of edges of the polygon and each of the plurality of survey lines based on the edge data structure; and
generating the path of the working device in the work area based on the at least one intersection.

2. The method of claim 1, wherein the generating the path comprises generating waypoints along the path by assigning ordinal numbers to the at least one intersection; and
connecting the waypoints in an ascending order or a descending order of the ordinal numbers.

3. The method of claim 1, wherein the generating the edge data structure comprises:
assigning an alignment order to vertices of the polygon based on coordinate values of the vertices of the polygon; and
generating topology information of the edges based on the alignment order of the vertices.

4. The method of claim 3, wherein the topology information comprises an edge direction of each edge and an edge number of each edge.

5. The method of claim 1, wherein a border of the survey area is determined by a maximum value and a minimum value of each of first and second axes-coordinate values of vertices of the polygon.

6. The method of claim 1, wherein the plurality of survey lines are arranged in parallel to a first axis or a second axis of a coordinate system at the predetermined interval corresponding to a work width of the working device performing a task in the survey area.

7. The method of claim 6, wherein a survey line of the plurality of survey lines, which is closest to a reference position of the survey area from among the plurality of survey lines, is at an interval corresponding to a half of the work width from the reference position.

8. The method of claim 1, wherein the detecting the at least one intersection comprises:
detecting an intersection between a target edge from among the edges and a target survey line from among the plurality of survey lines; and
changing the target edge or the target survey line based on the detecting the intersection between the target edge and the target survey line.

9. The method of claim 8, wherein the changing the target edge or the target survey line comprises:
in response to the intersection between the target edge and the target survey line being detected, changing the target survey line to a next survey line from among the plurality of survey lines based on an edge direction of the target edge; and
in response to no intersection between the target edge and the target survey line being detected, changing the target edge to a next edge from among the edges based on an edge number of the edge data structure.

10. An apparatus for planning a path of a working device, comprising a hardware processor to implement:
a first configuration unit configured to generate a polygon based on a work area of the working device and configured to generate an edge data structure based on the polygon;
a second configuration unit configured to generate a survey area based on the polygon and configured to generate a plurality of survey lines at a predetermined interval in the survey area; and
a third configuration unit configured to detect at least one intersection between each of edge of the polygon and each of the plurality of survey lines based on the edge data structure and generate the path of the working device in the work area based on the at least one intersection.

11. The apparatus of claim 10, wherein the first configuration unit is configured to assign an alignment order to vertices of the polygon based on coordinate values of the vertices and configured to generate topology information of the edges based on the alignment order of the vertices.

12. The apparatus of claim 11, wherein the topology information comprises an edge direction of each edge and an edge number of each edge.

13. The apparatus of claim 10, wherein a border of the survey area is determined by a maximum value and a minimum value of each of first and second axes-coordinate values of vertices of the polygon.

14. The apparatus of claim 10, wherein the plurality of survey lines are arranged in parallel to a first axis or a second axis of a coordinate system at the predetermined interval corresponding to a work width of the working device performing a task in the survey area.

15. The apparatus of claim 14, wherein a survey line of the plurality of survey lines, which is closest to a reference position of the survey area from among the plurality of survey lines, is at an interval corresponding to a half of the work width from the reference position.

16. The apparatus of claim 10, wherein the third configuration unit is configured to detect an intersection between a target edge from among the edges and a target survey line from among the plurality of survey lines and to change the target edge or the target survey line based on the detecting the intersection between the target edge and the target survey line.

17. The apparatus of claim 16, wherein the third configuration unit is configured to:
in response to the intersection between the target edge and the target survey line being detected, to change the target survey line to a next survey line from among the plurality of survey lines based on an edge direction of the target edge, and
in response to no intersection between the target edge and the target survey line being detected, to change the target edge to a next edge from among the edges based on an edge number of the edge data structure.

18. The apparatus of claim 10, wherein the third configuration unit is configured to generate waypoints along the path by assigning ordinal numbers to the at least one intersection; and configured to connect the waypoints in an ascending order or a descending order of the ordinal numbers.

19. A non-transitory computer-readable recording medium having embodied thereon a program for executing the method of claim 1.

20. A method of planning a path of a working device for performing a task in a work area, the method comprising:
generating a polygon based on the work area and generating an edge data structure based on the polygon, the edge data structure comprising:
a plurality of vertices; and
a plurality of edges connecting the plurality of vertices to form a border of the polygon;
generating a survey area surrounding the border of the polygon;
generating a plurality of survey lines at a predetermined interval in the survey area to intersect the plurality of edges of the polygon;
detecting intersections of the plurality of edges and the plurality of survey lines based on the edge data structure and generating a waypoint at each intersection; and
generating the path of the working device in the work area by connecting the waypoints at the intersections in a predetermined order.
